(19) United States
(12) Patent Application Publication
(10) Pub. No.: US 2008/0238797 A1
(43) Pub. Date: Oct. 2, 2008

(54) HORN ANTENNA ARRAY SYSTEMS WITH LOG DIPOLE FEED SYSTEMS AND METHODS FOR USE THEREOF

(76) Inventors: Corbett R. Rowell, Sha Tin (HK); Angus C.K. Mak, Sha Tin (HK)

Correspondence Address: FULBRIGHT & JAWORSKI L.L.P, 2200 ROSS AVENUE, SUITE 2800, DALLAS, TX, 75201-2784, US

(21) Appl. No.: 11/693,474

(22) Filed: Mar. 29, 2007

(51) Int. Cl. H01Q 13/02

(52) U.S. Cl. 343/776; 343/786

(57) ABSTRACT

An antenna array comprises a plurality of elements, at least one of the elements including a log dipole isolated from others of the elements by a horn structure.

### TECHNICAL FIELD

The description is related to antenna arrays and, specifically, to arrays of horn antenna elements.

### BACKGROUND OF THE INVENTION

Systems that include multiple antennas are in use in a variety of applications. In such systems the phenomena of mutual coupling between the elements is generally an important issue during the design phase. Mutual coupling occurs when the signal in one antenna element induces signals in other antenna elements. In multiple antenna systems this typically reduces the efficiency and gain of each element, since some of the energy from each element goes toward the coupling. Moreover, mutual coupling tends to distort the beam of each element, thereby reducing directivity and beamforming capacity.

Some prior art systems have attempted to reduce coupling (i.e., increase isolation) between antenna elements in multiple-element-systems. One such technique is to use complex three-dimensional structures similar to Photonic Band Gap (PBG) structures placed between the elements. However, PBG-type structures are complex, expensive, and sometimes large. Moreover, very high isolation can prevent beamforming and steering, since the elements would have very little effect on each other.

Currently, there is no system available that provides increased isolation with less complex structures, while at the same time providing the ability to perform beam steering and forming.

### BRIEF SUMMARY OF THE INVENTION

Various embodiments of the present invention are directed to a systems and methods which employ horn antenna elements with log dipole feeds. Horn structures with log dipole feeds provide isolation so that each element can be used to produce a beam with high gain and directivity when it is used independently of other elements. Further, multiple elements can be used to create wider beams and to steer beams.

Various embodiments of the invention are adaptable for different uses. The ability to produce more narrow and focused beams can facilitate beam switching and Multiple Input Multiple Output (MIMO) applications. Additionally, such embodiments are also adaptable for beamforming and beam steering.

Arrays according to one or more embodiments can be two-dimensional arrays (e.g., elements arranged on a plane) or three dimensional arrays (e.g., spherical arrangements). Further, the individual elements of the arrays can be two-dimensional or three-dimensional.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system adapted according to one embodiment of the invention;

FIG. 2 is an illustration of an exemplary antenna element adapted according to one embodiment of the invention;

FIG. 3 is an illustration of an exemplary antenna element adapted according to one embodiment of the invention;

FIG. 4 is an illustration of exemplary dipole structures and exemplary director/reflector structures adapted according to some embodiments of the invention;

FIG. 5A is an illustration of an exemplary antenna array adapted according to one embodiment of the invention;

FIG. 5B is an illustration of exemplary circuitry for use with the antenna of FIG. 5A;

FIG. 6A is a collection of graphs of farfield directivity for the array of FIG. 5;

FIG. 6B is an illustration of performance of an array that offers less isolation between elements than does the array of FIG. 5;

FIG. 6C includes a graph illustrating the farfield directivity of the array of FIG. 5;

FIG. 7 is an illustration of a number of example arrays according to various embodiments of the invention;

FIG. 8 is an illustration of an exemplary wireless router adapted according to one embodiment of the invention; and

FIGS. 9A-C illustrate exemplary methods adapted according to various embodiments of the invention.

### DETAILED DESCRIPTION OF THE INVENTION

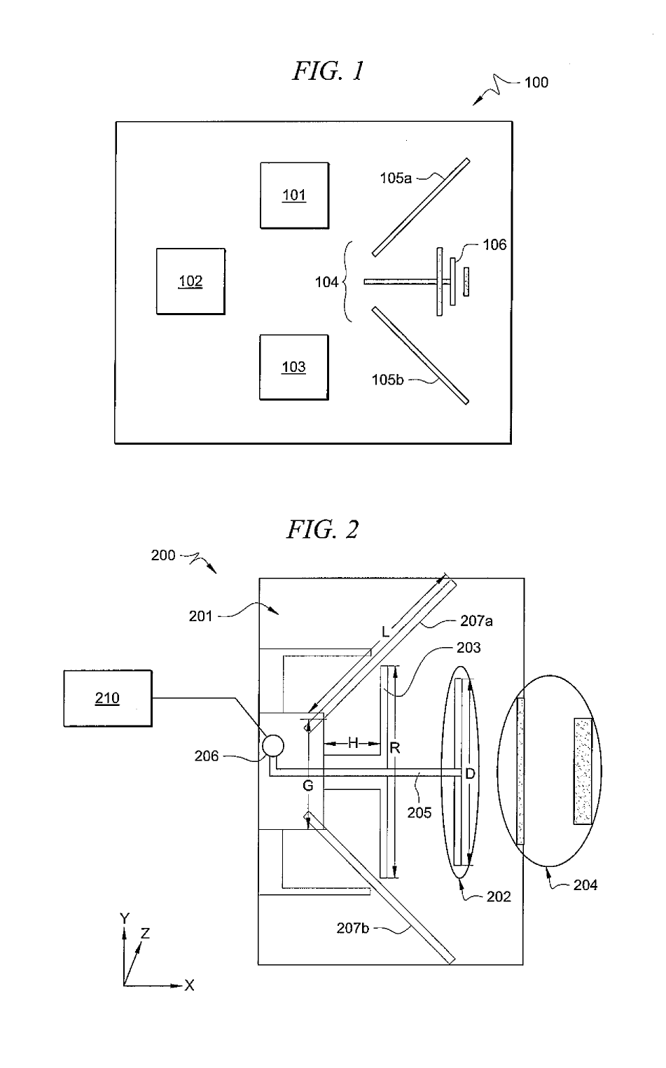

FIG. 1 is an illustration of exemplary system 100 adapted according to one embodiment of the invention. System 100 is an antenna array with a plurality of antenna elements 101-104. Antenna element 104 includes log dipole feed 106 that is isolated from elements 101-103 by horn structure 105. It is not required that the isolation be absolute, just that some isolation is provided by horn structure 105.

System 100 has four antenna elements, though other embodiments may include as few as two total elements and may be scaleable up to any number of elements that a design allows. Further, antenna elements 101-103 can, in some embodiments, be the same as or similar in structure to antenna element 104, or may be different. Antenna elements 101-103 are shown to illustrate a plurality of elements, and various embodiments are not limited to the arrangement shown in FIG. 1

FIG. 2 is an illustration of exemplary antenna element 200 adapted according to one embodiment of the invention. Antenna element 200 may be used in an array, such as array 100 of FIG. 1, with one or more other antenna elements (not shown). Antenna element 200 includes port 206, which in this example is a contact that is in communication with transceiver 210 to conduct Radio Frequency (RF) signals to and from dipole 202. Feed line 205 connects dipole 202 and port 206. Dipole 202 is referred to as a log dipole feed. The term, “log dipole” is short for “logarithmic dipole,” and it refers to a dipole structure that includes at least one director and at least one reflector. Examples of log dipoles include structures wherein the separation and length difference of the components is log-periodic (i.e., a logarithmic number), or follow the Fibonacci sequence, or are fractional multiples of wavelengths.

Dipole 202 is accompanied by other radiating elements—reflector 203 and directors 204. Some embodiments may omit any of elements 203 and 204 or may add or rearrange such elements, depending on the specific design.

Dipole 202 is isolated from other antenna elements (not shown) in the array by horn structure 207. In other words, horn structure 207 provides more isolation than would otherwise be experienced by an array that omits horn structure 207, usually by several decibels. In this example, horn structure 207 is a two-dimensional structure that includes arms 207a and 207b.

In this example various components (e.g., dipole 202) are formed as traces in Printed Circuit Board (PCB) 201; however, other embodiments may mount any of the various components using different techniques (e.g., a clip or stand) and may also use different structures (e.g., rounder or thicker wires, tubes, and the like) for the various components. Embodiments of the invention are not necessarily limited to any particular mounting technique or to any particular kinds of materials.

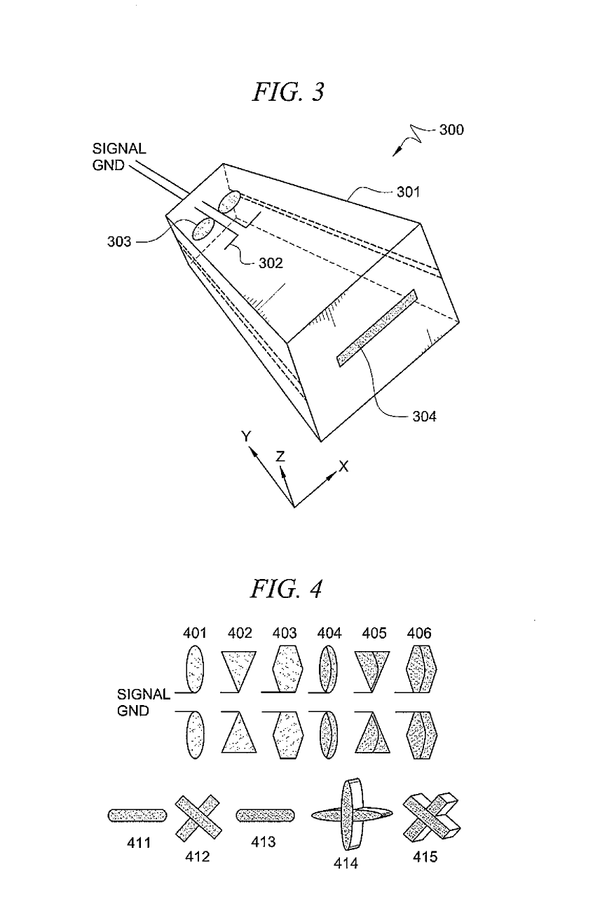

FIG. 3 is an illustration of exemplary antenna element 300 adapted according to one embodiment of the invention. Antenna element 300 is a three-dimensional horn element, in contrast to the two-dimensional horn element shown above in FIG. 2, and it may be included in arrays according to various embodiments. Antenna element 300 includes horn structure 301 that surrounds dipole element 302 and reflector 303 in three dimensions. Antenna element 300 also includes director 304.

FIG. 4 is an illustration of exemplary dipole structures 401-406 and exemplary director/reflector structures 411-415 adapted according to some embodiments of the invention. Dipoles 401-406 illustrate that dipole shapes other than straight wires can be used and that some embodiments may use three-dimensional structures, such as dipoles 404-406, in addition to or alternatively to “flat” structures 401-403. Additionally, structures 411-415 show shapes that may be used in the manufacture of reflectors/directors. Various embodiments may use either two-dimensional or three-dimensional structures and are not limited to any particular shape for radiating elements.

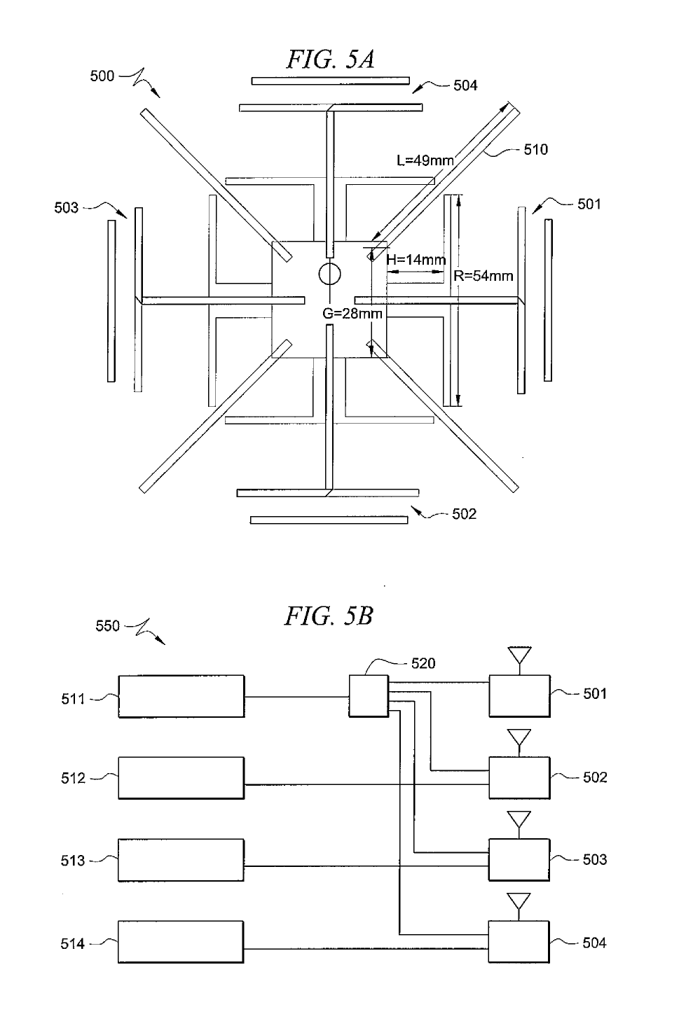

FIG. 5A is an illustration of exemplary antenna array 500 adapted according to one embodiment of the invention. Array 500 is a two-dimensional array of four antenna elements 501-504, each configured like that shown in FIG. 2. Antenna elements 501-504 are arranged such that each element is ninety degrees turned from its adjacent neighbor. Further, each element 501-504 shares a horn structure with its adjacent neighbor. For instance, elements 501 and 504 share horn structure 510. Such sharing can, in some embodiments, save space and cost with little or no loss in performance when compared to embodiments that do not share horn structures. While not shown, it should be noted that arrays of three-dimensional elements can also include horn structure sharing arrangements and that some embodiments, whether two- or three-dimensional, may not include horn structure sharing.

Array 500 is shown with dimensions included. With such dimensions, system 500 operates in a frequency band centered around 2.45 GHz. Such measurements are included for illustrative purposes only, as various embodiments may include other dimensions. In fact, Respective lengths G, H, R, and L can be adjusted to provide desired performance in a given embodiment. For instance, a smaller length for R will generally result in performance at higher frequencies, and increased length of L will usually cause greater isolation among elements 501-504.

FIG. 5B is an illustration of exemplary circuitry 550 for use with array 500. Circuitry 550 includes transceivers 511-514, with transceiver 511 being a master transceiver. Switch 520 can be used to turn any of elements 501-504 on and off, at least with respect to transceiver 511. For example, switch 520 can connect antenna element 501 on and turn other antenna elements 502-504 off thereby sending and receiving signals with transceiver 511 and element 501. Similarly, switch 520 can turn all of antennas 501-504 off or can turn any combination of elements 501-504 on. This can facilitate beam switching and beam forming (described more fully below).

Additional transceivers 512-514 facilitate sending and receiving multiple data streams using multiple antenna elements. For example, array 500 can send and receive up to four different data streams. Thus, circuitry 550 provides at least one way that array 500 can be used for MIMO and also for beam switching and beamforming. In fact, circuitry 550 can be used to switch between modes during operation, wherein one mode is MIMO and another mode is a beam switching/beam forming mode. Further, although not shown for simplicity, it is understood that circuitry 550 can include, in some embodiments, other components (e.g., switches, attenuators, amplifiers, and phase shifters) for use in transmitting/receiving.

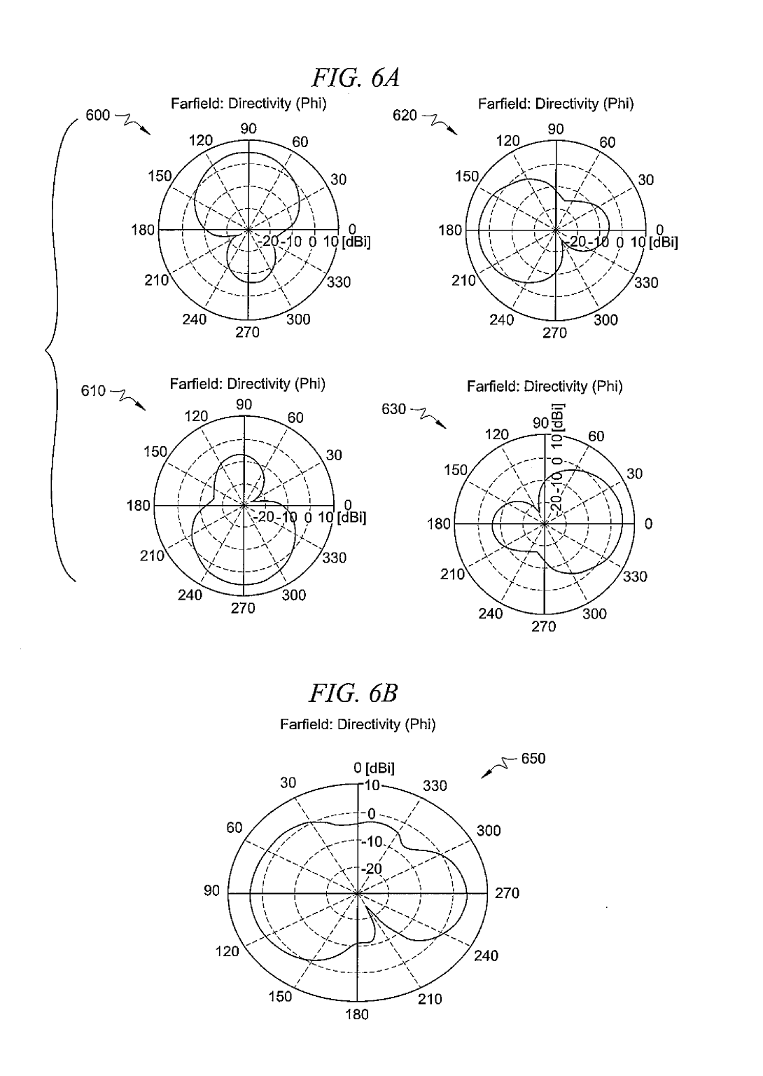

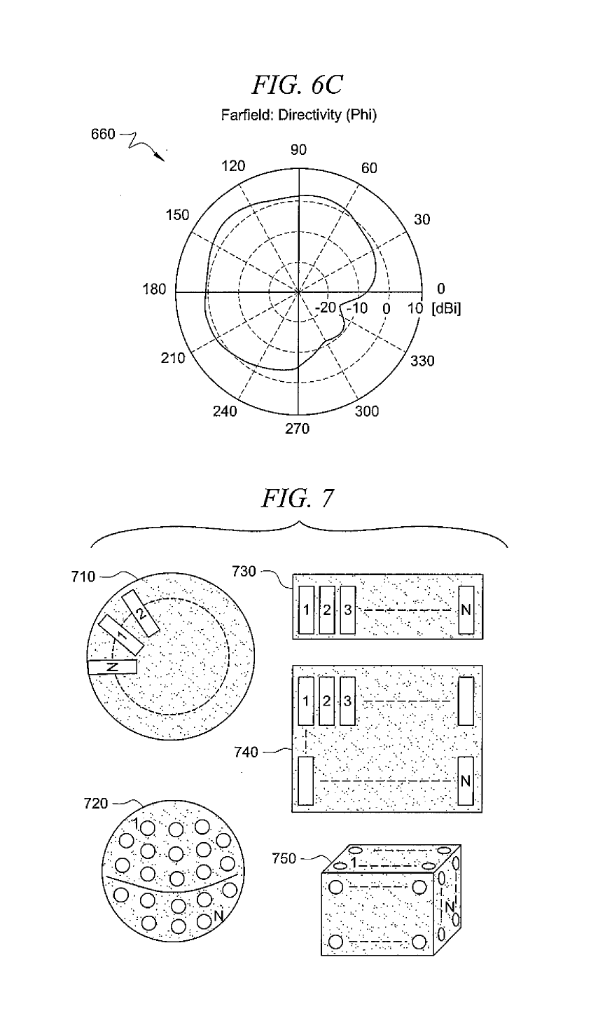

FIG. 6A is a collection of graphs 600, 610, 620, and 630 of farfield directivity for array 500. Graph 600 illustrates farfield directivity for array 500 when antenna element 504 is fed an RF signal at 2.45 GHz while the other antenna elements 501-503 are not fed an RF signal. Graph 610 illustrates farfield directivity for array 500 when antenna element 502 is fed an RF signal at 2.45 GHz while the other antenna elements 501, 503, and 504 are not fed an RE signal. Graph 620 illustrates farfield directivity for array 500 when antenna element 503 is fed an RF signal at 2.45 GHz while the other antenna elements 501, 502, and 504 are not fed an RF signal. Similarly, Graph 630 illustrates farfield directivity for array 500 when antenna element 501 is fed an RE signal at 2.45 GHz while the other antenna elements 502-504 are not fed an RF signal.

Graph 600 shows that antenna element 504, in this scenario, has a main lobe magnitude of 5.1 dB, a side lobe magnitude of −11.7 dB, and a 3 dB angular width of 70.8 degrees. The other graphs 610, 620, and 630 show similar performance with ninety degree spatial shifts.

FIG. 6B is offered for comparison of performance between array 500 (FIG. 5) and an array that offers less isolation between elements. Specifically, FIG. 6B includes graph 650 showing the farfield directivity of an array (not shown) similar to array 500 but without horn structures (e.g., 510), wherein a dipole element situated similarly to that of element 503 is fed an RF signal at 2.45 GHz while the other elements are not fed an RF signal. As can be seen, increased coupling in the array results in less directivity and a larger side lobe than that seen for array 500.

In addition to allowing for narrow, directional beams, various embodiments of the invention can also be used for beamforming and providing wider beams. FIG. 6C includes graph 660, illustrating the farfield directivity of array 500 when antenna elements 504 and 503 are fed an RF signal at 2.45 GHz, each at the same power, and the other antenna elements 501 and 502 are not fed an RF signal. Graph 660 shows a main lobe centered at 135 degrees and a magnitude of 3.3 dB and a side lobe with a magnitude of −14.4 dB. The shape and direction of the beam can be adjusted by changing the relative power amplification for antennas 503 and 504. For instance, greater power amplification with regard to element 504 will generally result in a main lobe that is centered closer to the 90 degree mark in graph 660, though the size of the side lobe and the symmetric quality of the beam will also be affected. Wide beams can be produced by utilizing any two, any three, or all four of elements 501-504 at the same time with the same signal. In some embodiments, a control system (e.g., including a transceiver) is used to dynamically steer a beam by selectively feeding and amplifying the various antenna elements. In an array that arranges elements in two dimensions (e.g., array 500), such beam forming can be used to provide beamforming and steering up to 360 degrees. Similarly, an array that arranges elements in three dimensions can be used to provide beam steering and beamforming up to 4π steradians.

In addition to beamforming and beam steering, various embodiments can be used to provide beam switching. For instance, in array 500 (FIG. 5), a control system can selectively feed any one of elements 501-504 to provide a narrow, focused beam by switching a feed among elements 501-504. Thus, array 500 can be used to provide a beam centered at approximately 0 degrees, 90 degrees, 270 degrees, and 360 degrees. Steering, forming, and switching can be used in many applications, especially applications that involve moving transmitters and/or receivers so that a beam can be selected that provides optimal performance for a given spatial relationship.

The functions described above can be accomplished with a single signal feed (e.g., one connection to a transaction, the connection provided to a switching mechanism that can provide the signal to some or all of the elements at a given time). The provision of multiple signal feeds can be used to add other functions to arrays according to embodiments of the invention. For instance, in array 500, a number of transceivers and switches (not shown) can be used to provide independent signals to elements 501-504, thereby allowing multiple data streams to be sent and/or received simultaneously. Increased isolation among elements 501-504 facilitates the use of the spatial diversity techniques. Thus, embodiments of the invention, such as array 500, can be used in MIMO applications. Such embodiments are not necessarily mutually exclusive to embodiments that provide beam steering and beamforming, such that some embodiments can steer two or more beams, each carrying an independent data stream.

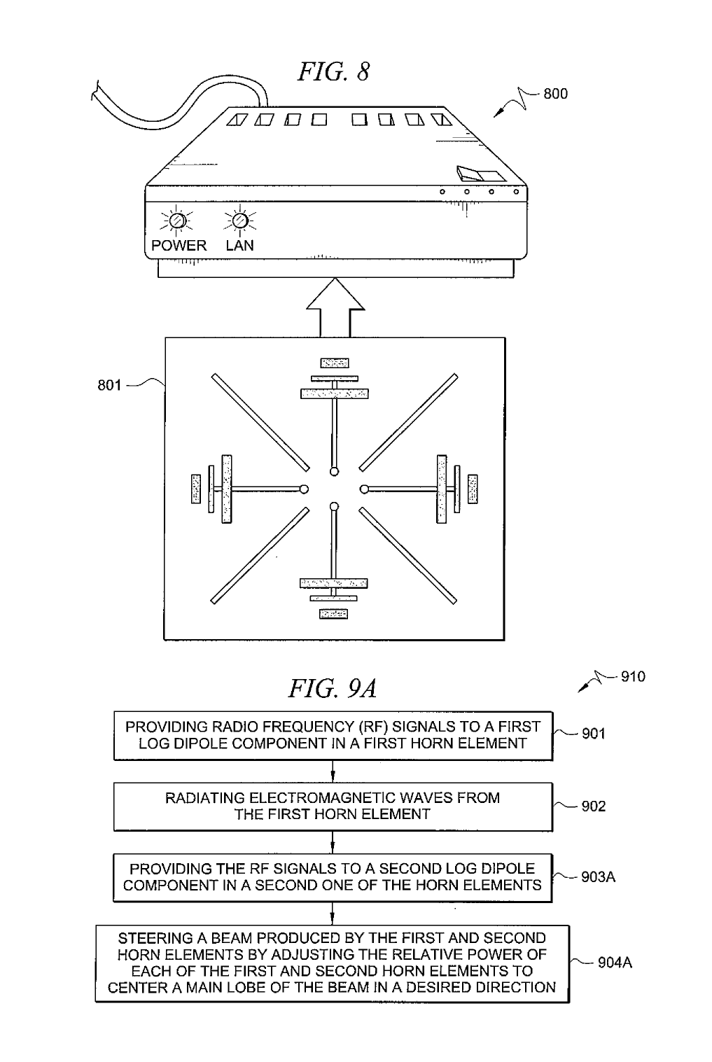

The examples above are described with regard to array 500 of FIG. 5A for convenience. It should be noted that embodiments of the invention can include a wide variety of element shapes and arrays. FIG. 7 is an illustration of a number of example arrays according to various embodiments of the invention. Array 710 is a cylindrical array, wherein N elements (either two- or three-dimensional elements) are arranged around an axis. Array 720 is a spherical array wherein N three-dimensional elements face outward from a spherical arrangement. Array 730 is a one-dimensional linear array, wherein elements (two- or three-dimensional) are arranged in a row. Array 740 is a two-dimensional linear array, wherein elements (two- or three-dimensional) are arranged in rows and columns. Array 750 is a three-dimensional linear array wherein three-dimensional elements face out from a rectangular prism arrangement. The variety of arrays shown in FIG. 7 is not exclusive, as other kinds of arrays (e.g., irregularly shaped arrays) are adaptable in some embodiments of the invention.

Many applications can benefit from embodiments of the present invention. For example, wireless routers and network interface cards that use IEEE 802.11 protocols (including 802.11n) can benefit from beamforming, beam steering, beam switching, and MIMO functionality that is facilitated by some arrays according to the present invention. FIG. 8 is an illustration of example wireless router 800 adapted according to one embodiment of the invention. Router 800 includes array 801, which is an array similar to array 500 of FIG. 5A. The invention is not limited in application to 802.11 embodiments, as any device that can benefit from antenna arrays with increased inter-element isolation may be a candidate, including cellular telephones, satellite antennas, and the like.

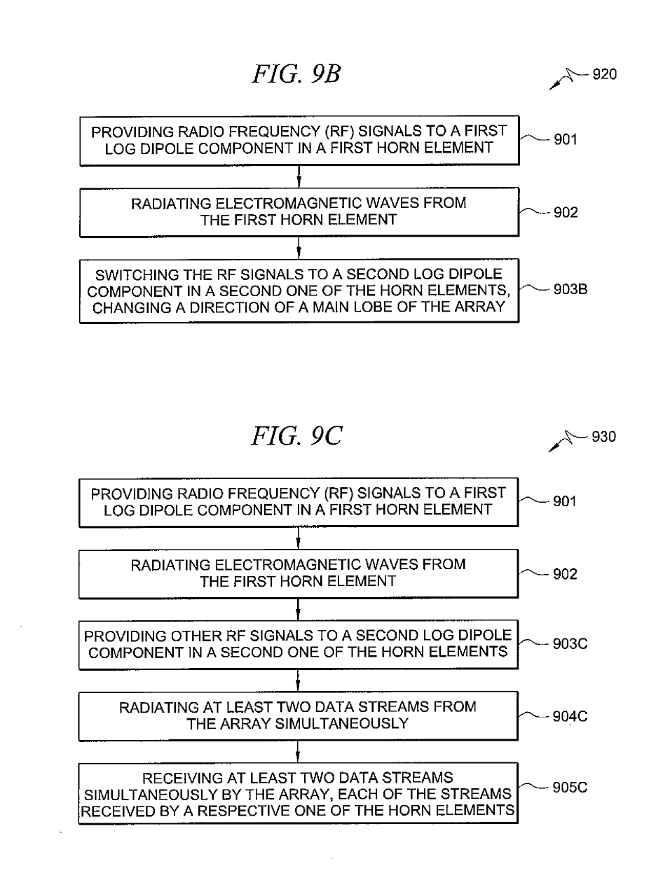

FIGS. 9A-C illustrate example methods 910, 920, and 930 adapted according to one embodiment of the invention. Methods 910, 920, and 930 may be performed by a system that includes an array, the array conforming to one or more embodiments of the invention. In some examples, the system performs one or more of method 910, 920, and 930 through use of an RF unit (e.g., a transceiver) that is capable of providing one or more data stream signals to the array and receiving one or more data streams from the array.

In step 901, a Radio Frequency (RF) signal is provided to a first log dipole component in a first horn element. In step 902, electromagnetic waves are radiated from the first horn element. The radiated waves form a beam that carries a data stream.

Steps 903A and 904A are performed by systems that provide beam forming and/or steering. In step 903A, the RF signals are provided to a second log dipole component in a second one of the horn elements. In one embodiment, an RF transceiver sends the RF signal to both the first and second elements at the same time, thereby forming a beam that is different from that of the first element alone. In step 904A, the beam produced by the first and second horn elements is steered by adjusting the relative power of each of the first and second horn elements to center a main lobe of the beam in a desired direction. While FIG. 9A refers to two elements, other embodiments may form beams and steer beams with three or more elements. Although not explicitly shown in the FIGURES, it is noted that beamforming and steering can also be performed by an array that is receiving signals by, e.g., turning antennas on and off and/or weighting the received signals.

Step 903B can be performed by a system that provides beam switching. In step 903B, the RF signals are switched to a second log dipole component in a second one of the horn elements, changing a direction of a main lobe of the array. Step 903B can be repeated among a group of two or more antenna elements, thereby providing a variety of directional beams. Once again, although not explicitly shown in the FIGURES, it is noted that beam switching can also be performed by an array that is receiving signals by, e.g., operating a transceiver to switch between selected elements during signal reception.

Steps 903C to 905C can be performed by a system that provides different RF signals to different ones of the horn elements, e.g., by employing one or more transceivers that are operable to send and receive different signals to/from multiple ports. For instance, in step 903C, other RF signals are provided to a second log dipole component in a second one of the horn elements. In step 904C, at least two independent data streams are radiated from the array simultaneously. In step 905C, at least two data streams are received simultaneously by the array, each of the streams received by a respective one of the horn elements. An embodiment according to FIG. 9C can be used, e.g., in MIMO applications.

Methods 910, 920, and 930 are shown as series of discrete steps. However, other embodiments of the invention may add, delete, repeat, modify and/or rearrange various portions of methods 910, 920, and 930. For instance, various steps (e.g., 901-903A, 901-903B, 901-904C) are generally performed simultaneously in some embodiments. Further, various steps (e.g., 901-904A, 901-903B, 901-905C) may be repeated indefinitely to provide continuous performance to an application, such as a wireless router. Moreover, some systems according to the embodiments herein may be configured to provide beamforming/beam steering and MIMO communications in different modes.

Various embodiments of the invention provide one or more advantages over prior art systems. For instance, various embodiments provide more isolation between elements compared to dipole arrays that do not include horn structures. Increased isolation can facilitate increased efficiency since beams can be produced that are more symmetric and have higher main lobe/side lobe ratios, at least when switching between selected single elements and/or providing independent data streams (e.g., MIMO). However, in the same embodiments, beam steering and beamforming can be performed by sending RF signals to two or more such elements. Thus, various designs can be used in many embodiments, including directional beam embodiments as well as MIMO embodiments without changing the antenna structure. Instead, different operating modes can be achieved through control of one or more transceivers in communication with a given array.

Further, some embodiments can share horn structures between adjacent elements, as in FIG. 5. Such embodiments may make more efficient use of space in a design, as well as saving in materials costs.

Moreover, some embodiments (e.g., arrays of two-dimensional elements, as in FIG. 5) can be produced relatively inexpensively by using a Printed Circuit Board (PCB) as a substrate and disposing horn structures and log dipoles thereon through etching. In other words, some embodiments provide increased performance at a negligible cost increase over other PCB-based antennas.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An antenna array comprising:
a plurality of elements, at least one of said elements including a log dipole isolated from others of said elements by a horn structure.

2. The antenna array of claim 1, wherein said horn structure is a two-dimensional horn structure.

3. The antenna array of claim 1 wherein said horn structure is a three-dimensional horn structure.

4. The antenna array of claim 3 wherein said array is a three-dimensional array.

5. The antenna array of claim 1 wherein said plurality of elements comprises:
at least four log dipole elements arranged on a plane with ninety degree separation, wherein adjacent log dipole elements share horn structure walls.

6. The antenna array of claim 1 comprising a plurality of ports in communication with said plurality of elements.

7. The antenna array of claim 1 further comprising a Radio Frequency (RF) signal system providing at least two different RF signal feeds to said array.

8. The antenna array of claim 7 wherein said RF signal system is a Multiple Input Multiple Output (MIMO) system.

9. The antenna array of claim 1 further comprising a RF signal system switching an RF signal feed among at least two different elements in said array.

10. The antenna array of claim 1 further comprising a RE signal system providing a same RF signal feed to at least two different elements in said array, producing a broad beam pattern.

11. The antenna array of claim 1, wherein said array is employed in a wireless router to transmit one or more data streams.

12. A method for operating an antenna array that includes a plurality of horn elements each fed by log dipole components, said method comprising:
providing Radio Frequency (RF) signals to a first log dipole component in a first one of said horn elements;
radiating electromagnetic waves from said first horn element.

13. The method of claim 12 further comprising:
receiving other RF signals over the air by said first horn element; and
feeding said received signals to an RF transceiver.

14. The method of claim 12 further comprising:
providing said RF signals to a second log dipole component in a second one of said horn elements; and
steering a beam produced by said first and second horn elements.

15. The method of claim 14 wherein said steering comprises:
adjusting the relative power of each of said first and second horn elements to center a main lobe of said beam in a desired direction.

16. The method of claim 12 further comprising:
switching said RF signals to a second log dipole component in a second one of said horn elements, changing a direction of a main lobe of said array.

17. The method of claim 12 further comprising:
providing other RF signals to a second log dipole component in a second one of said horn elements; and
radiating at least two data streams from said array simultaneously.

18. The method of claim 17 further comprising:
receiving at least two data streams simultaneously by said array, each of said streams received by a respective one of said horn elements.

19. An antenna array comprising:
two or more horn elements in said array fed by log dipole structures.

20. The antenna array of claim 19 wherein adjacent horn elements share horn structures.

21. The antenna array of claim 19 wherein said horn elements are arranged on a plane around a central axis perpendicular to the plane.

22. The antenna array of claim 19 further comprising:
a transceiver providing an RF signal and operable to switch said RF signal among said horn elements.

23. The antenna array of claim 19 further comprising:
a transceiver providing an RF signal to multiple ones of said two or more horn elements and operable to steer a beam formed by said multiple ones of said two or more horn elements.

24. The antenna array of claim 19 further comprising:
a transceiver providing two or more RF signals such that said array radiates two or more independent data streams simultaneously.

25. The antenna array of claim 19, wherein said array is employed in a wireless router to transmit one or more data streams.

26. An array comprising:
a first horn element with a first log dipole feed;
a second horn element with a second log dipole feed;
a third horn element with a third log dipole feed;
a fourth horn element with a fourth log dipole feed;
wherein said horn elements are two-dimensional horn elements arranged on a plane, and wherein adjacent ones of said horn elements share a portion of horn structure.

27. The array of claim 26 wherein said horn elements are arranged on said plane at ninety degree increments.

28. The array of claim 26 further comprising:
a transceiver providing an RF signal and operable to switch said RF signal among said horn elements.

29. The array of claim 26 further comprising:
a transceiver providing an RF signal to multiple ones of said horn elements and operable to steer a beam formed by said multiple ones of said horn elements.

30. The array of claim 26 further comprising:
a transceiver providing two or more RF signals such that said array radiates two or more independent data streams simultaneously.

31. The array of claim 26, wherein said array is employed in a wireless router to transmit one or more data streams.

32. An antenna array comprising:
a plurality of spatially diverse antenna elements;
a plurality of transceivers, each of the transceivers in communication with at least one of said antenna elements, and a master transceiver in communication with two or more of said antenna elements;
wherein said antenna array is operable to function in at least two modes during operation:
a first mode providing Multiple Input Multiple Output (MIMO) functionality through said plurality of transceivers; and
a second mode providing beam switching functionality through said master transceiver.

33. The antenna array of claim 32 wherein said antenna elements comprise a plurality of horn elements, each fed by a log dipole.
